(19) United States
(12) Patent Application Publication
(10) Pub. No.: US 2007/0081561 A1
(43) Pub. Date: Apr. 12, 2007

(54) Single ended solution for estimation of bandwidth delay product

(75) Inventors: Ivan M. Heninger, Selma, NC (US); Justin H. Holcomb, Durham, NC (US); John D. Kari, Coeur d Alene, ID (US); Eric Otchet, Tinton Falls, NJ (US)

Correspondence Address: HOFFMAN WARNICK & DALESSANDRO LLC, 75 STATE ST, 14TH FLOOR, ALBANY, NY, 12207, US

(73) Assignee: International Business Machines Corporation, Armonk, NY (US)

(21) Appl. No.: 11/247,009

(22) Filed: Oct. 11, 2005

(51) Int. Cl. H04J 3/06

(52) U.S. Cl. 370/516

(57) ABSTRACT

The present invention provides a method, system, and computer program product for estimating the bandwidth delay product at a single node of a network by calculating the delay of a data packet transmission at that node, also determining observed bandwidth at that node, and then multiplying the delay by the observed bandwidth from this single node.

### BACKGROUND OF THE INVENTION

1. Field of the Invention

The present invention generally relates to estimating bandwidth delay product, and more specifically relates to a method, system, and computer program product for estimating bandwidth delay product from a single node and without the need for test data or probe packets of any sort.

2. Related Art

In order to maximize performance in network communications, optimization of the TCP window size for each TCP session is a desired goal. Estimating the bandwidth delay product (“BDP”) is used to aid in determining the TCP window size.

BDP determines the amount of data that can be in transit within a particular network and is the product of the available bandwidth and the latency, or round trip time (“RTT”). Thus, BDP is found via the following equation 1:
BDP(bits)=Total_available_bandwidth(bits/sec)×round_trip_time(sec) Eq. 1

Or, in alternative units, BDP in bytes, is shown via equation 2:
BDP(bytes)=Total_available_bandwidth(Kbytes/sec)×round_trip_time(ms) Eq. 2

Being that the TCP window is a buffer that decides the quantity of data that can be transmitted before a server waits for acknowledgement, BDP is determinative of the TCP window size. Thus, if BDP is less than the product of latency and available bandwidth, the line of data cannot be filled because an acknowledgement cannot respond quickly enough. As a result, a transmission cannot exceed the RWIN/latency value. So, RWIN (i.e., Receive WINdow) must be sized suitably to allow for the maximum bandwidth×maximum delay.

In practical terms, BDP is currently found by sending probe packets (i.e., test data) out into the network and measuring the latency of the probe packets (e.g., “ping”) being sent between at least two nodes (e.g., routers). Being that test data as opposed to actual data is being measured and therein loosely applying Heisenberg's Uncertainty Principle, the current BDP calculation methods are not entirely realistic and accurate. Current BDP calculation also requires out of band signaling.

Shortcomings to the current BDP calculation methods include the requirement of multiple nodes, or endpoints, to calculate. The calculation methods are further obfuscated by VPN encapsulation.

A need exists for an improved bandwidth delay product calculation method that overcomes the above, and perhaps other, disadvantages of current bandwidth delay product calculation methods.

### SUMMARY OF THE INVENTION

The present invention provides a method, system, and computer program product for estimating bandwidth delay product.

A first aspect of the present invention is directed to a method for estimating bandwidth delay product at a single node, comprising: calculating delay at the single node of a data packet transmission; determining observed bandwidth at the single node; and multiplying the delay by the observed bandwidth, thereby obtaining an estimated bandwidth delay product.

A second aspect of the present invention is directed to a system for estimating bandwidth delay product at a single node, comprising: a system for calculating delay at the single node of a data packet transmission; a system for determining observed bandwidth at the single node; and a system for multiplying the delay by the observed bandwidth, thereby obtaining an estimated bandwidth delay product.

A third aspect of the present invention is directed to a program product stored on a computer readable medium for estimating bandwidth delay product at a single node, the computer readable medium comprising program code for performing the steps of: calculating delay at the single node of a data packet transmission; determining observed bandwidth at the single node; and multiplying the delay by the observed bandwidth, thereby obtaining an estimated bandwidth delay product.

A fourth method of the present invention is directed to a method for deploying an application for estimating bandwidth delay product at a single node, comprising: providing a computer infrastructure being operable to: calculate delay at the single node of a data packet transmission; determine observed bandwidth at the single node; and multiply the delay by the observed bandwidth, thereby obtaining an estimated bandwidth delay product.

A fifth method of the present invention is directed to computer software embodied in a propagated signal for estimating bandwidth delay product at a single node, the computer software comprising instructions to cause a computer system to perform the following functions: calculating delay at the single node of a data packet transmission; determining observed bandwidth at the single node; and multiplying the delay by the observed bandwidth, thereby obtaining an estimated bandwidth delay product.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a portion of a network configured to determine delay (i.e., time to acknowledge) of a packet, in accordance with an embodiment of the present invention.

FIG. 2 depicts a progression, over time, of a close up of queuing of unacknowledged packets at the VPN endpoint in FIG. 1, in accordance with an embodiment of the present invention.

FIG. 3 depicts a portion of a network configured to determine the observed bandwidth, in accordance with an embodiment of the present invention.

FIG. 4 depicts a progression, over time, of a close up of queuing of unacknowledged packets at the VPN endpoint in FIG. 3, in accordance with an embodiment of the present invention.

FIG. 5 depicts a progression, over time, of a network utilizing the calculated bandwidth delay product, in accordance with an embodiment of the present invention.

FIG. 6 depicts an illustrative computer system for implementing embodiment(s) of the present invention.

FIG. 7 depicts a method, in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, the present invention provides a method, system, and computer program product for calculating bandwidth delay product in a novel way. In particular, the present invention provides for a bandwidth delay product calculation method that can be accomplished from a single endpoint within the network utilizing actual data packets. Instead of using multiple nodes, as with current BDP calculation methods, the current invention requires a single endpoint to calculate BDP. Rather than utilizing probe data, the current invention uses the actual data packets in its calculation. Further, although the present invention can assist in TCP window sizing, it may be employed for other controls including compression, protocol header reduction, and the like.

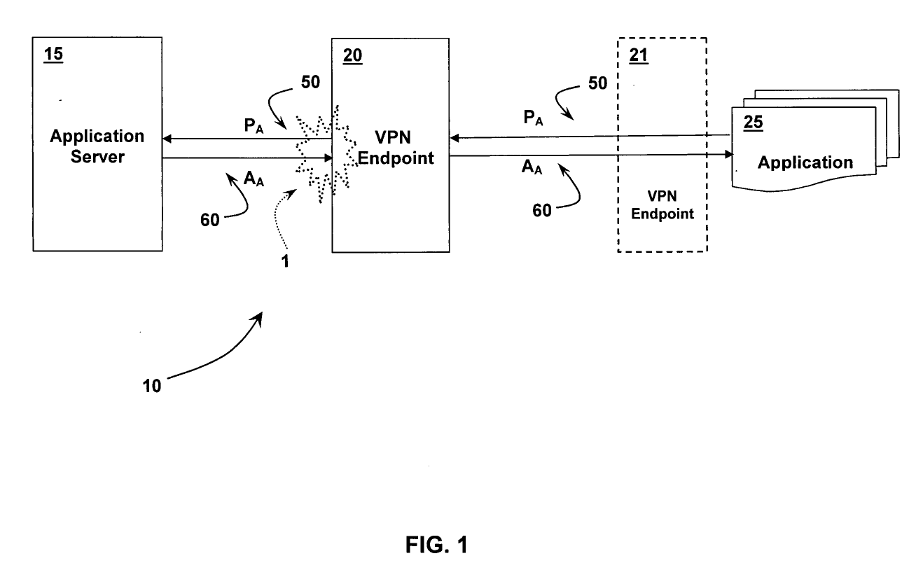

A diagram of a portion of a network 10 wherein the calculation of delay (i.e., time to acknowledge) may be performed in accordance with an embodiment of the present invention is illustrated in FIG. 1. Network 10 includes a first node (e.g., VPN endpoint) 20, an application server 15, a second node (e.g., VPN endpoint) 21 and an application 25 all in communication with each other. Clearly, all these elements 15, 20, 25 may be in pluralities. However, single elements are shown for clarity purposes, in that the invention may be carried at the first, single VPN endpoint (i.e., node) 20.

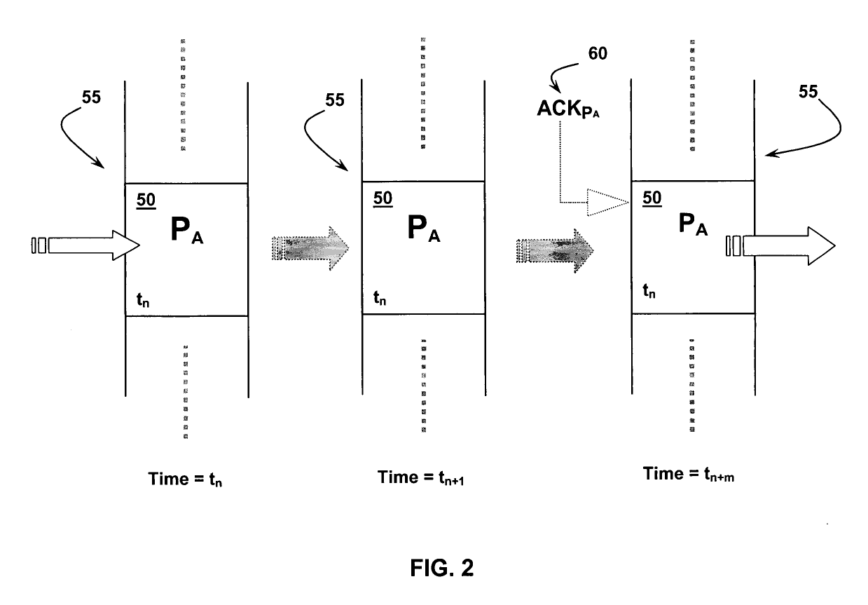

Packets (P_{A}) of data 50 are transmitted from the application 25 and second VPN endpoint 21 through the first VPN endpoint 20 and to the application server 15. Similarly, acknowledgements (A_{A}) of the data 60 are sent back from the application server 15 through the first VPN endpoint 20 on to the second VPN endpoint 21 and the application 25. In this manner packets 50, and queues 55 of packets 50 (FIG. 2) and the concomitant acknowledgements 60 pass through the VPN endpoint 20.

It should be noted that a similar, but alternative, process of transmission that employs the present invention also exists wherein the packets of data 50 and acknowledgements of data 60 flow in the opposite direction. That is Packets (P_{A}) of data 50 are transmitted from the application server 15 through the first VPN endpoint 20 and on to the second VPN endpoint 21 and on to the application 25. Similarly, acknowledgements (A_{A}) of the data 60 are sent back from the application 25 and second VPN endpoint 21 through the first VPN endpoint 20 and on to the application server 15. Thus, the present invention is able to estimate a bandwidth delay product at a single node (e.g., VPN endpoint) 20 in an asymmetric network in either direction of data transmission independently.

FIG. 2 depicts a close-up (i.e., portion 1 in FIG. 1) of a progression over time of one particular packet P_{A} of packets 50 in a queue 55 of unacknowledged packets 50 that is encountered at the VPN endpoint 20. Over this time progression, and activity of the particular packet P_{A}, the delay (i.e., time to acknowledge) is calculated by the invention. At an arbitrary starting time at time=tₙ packets 50 enter the queue 55. Upon entering the queue 55, the time of entry is recorded as E_{PA}=tₙ at the VPN endpoint 20.

Time progresses, as denoted by shaded arrows, to time=tn+l as the queue 55 is transmitted.

Later, at time=tn+m an acknowledgement ACK_{PA} 60 of P_{A} 50 arrives and packet P_{A} 50 is removed from the queue 55. Similarly, the time of exit of the packet 50 is recorded as A_{PA}=tₙ₊ₘ.

As a result, the time to acknowledge (i.e., delay) is calculated by determining the difference, from above, as the following equation:
Time to acknowledge=E_{PA}−A_{PA}=tₙ₊ₘ−tₙ Eq. 3

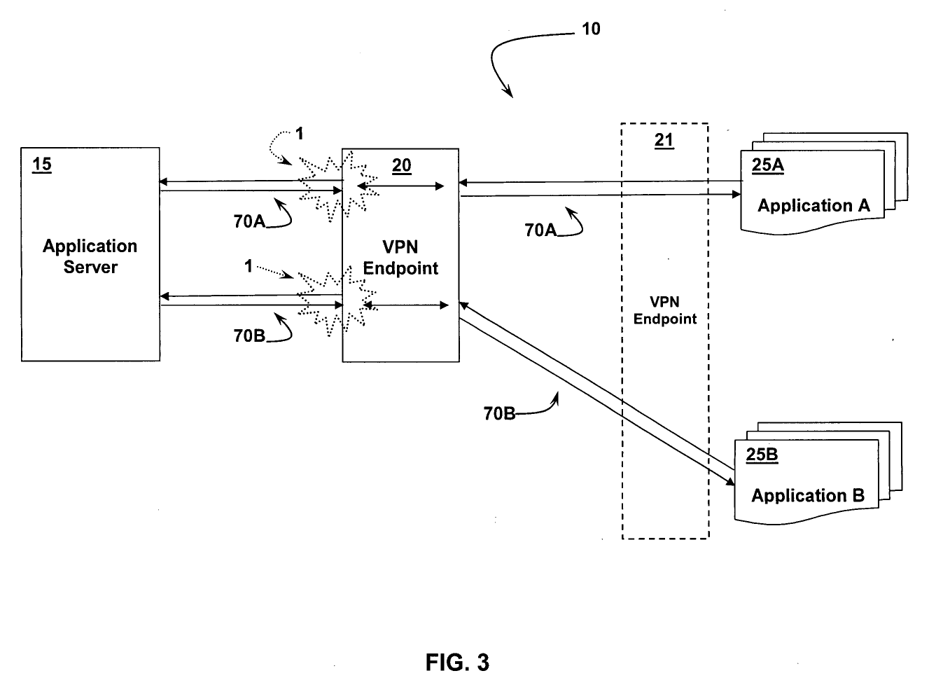

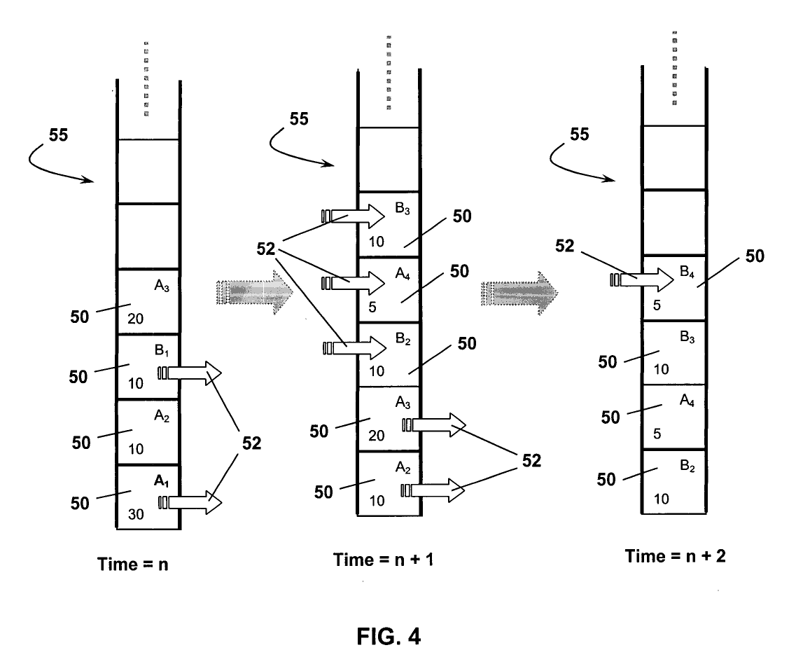

FIGS. 3 and 4 show a similar network 10 and methodology in determining the observed bandwidth at a single VPN endpoint 20. A portion of a network 10 is shown with VPN endpoint (node) 20, application server 15, and applications 25A, 25B with a second VPN endpoint (node) 21. Typical data transmission is shown as TCP sessions 70A and 70B between applications 25A, 25B (and second VPN endpoint 21); first VPN endpoint 20; and, application server 15. For example, first application 25A includes TCP session 70A and second application 25B includes TCP session 70B.

FIG. 4 shows a close up portion 1 from FIG. 3. As shown in FIG. 4, over time, a queue 55 of unacknowledged packets 50 are observed at VPN endpoint 20 as they enter and exit the queue 55. From these observations the present invention is able to make several determinations related to the bandwidth.

The plurality of packets 50 include a notation in FIG. 4 as follows:

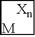

Where, Xn, connotes a packet 50 of a tag, or session, X, having a sequence, n, being of byte size M. For example, the particular packet 50A, in FIG. 4, is a packet 50 from tag, or session “A”, sequence “1”, having a byte size of 30 bytes.

Turning to FIG. 4, at time=n, a data packet queue 55, having a queue size of 70 bytes total, made up of a plurality of packets 50, is observed. The queue 55 includes packets 50 (i.e., A₃ of 20 bytes; B, of 10 bytes; A₂ of 10 bytes; and, A₁ of 30 bytes).

Between time=n and time=n+1, certain packets 50 are transmitted 52 both out of and into the queue 55. For example, the two specific packets 50 that are transmitted 52 out of the queue 55 between time=n and n+1 are B₁ of 10 bytes and A₁ of 30 bytes. Similarly, between time=n and n+1, the three specific packets 50 that are transmitted 52 into the queue 55 are B₃ of 10 bytes; A₄ of 5 bytes; B₂ of 10 bytes. Thus, from the time=n to time=n+1 the queue 55 shrinks in overall byte size from 70 bytes (time=n) to 55 bytes (time=n+1) via the transmission out of queue 55 of 40 bytes (existing) and the transmission into the queue 55 of 25 bytes (new).

Thus, at time=n+1, the data packet queue 55, having a queue size of 55 bytes total, made up of a plurality of packets 50, is observed. The specific packets 50 in the queue 55 at time=n+1 include B₃ of 10 bytes; A₄ of 5 bytes; B₂ of 10 bytes; A₃ of 20 bytes; and A₂ of 10 bytes. Whereas, packets 50 B₃, A₄ and B₂ were transmitted into the queue since time=n, packets 50 A₃ and A₂ have been in the queue 55 since, at least time=n.

The observation of queue size and the quantity of transmitted packets 52 continues on from time=n+1 on to time=n+2. Thus, at time=n+2, a data packet queue 55, having a queue size of 30 bytes total, made up of a plurality of packets 50 (i.e., B₄ of 5 bytes; B₃ of 10 bytes; A₄ of 5 bytes; and, B₂ of 10 bytes), is observed.

Between time=n+1 and time=n+2, certain packets 50 are transmitted 52 both out of and into the queue 55. Thus, the two specific packets 50 that are transmitted 52 out of the queue 55 between time=n+1 and n+2 are A₃ of 20 bytes and A₂ of 10 bytes. Similarly, between time=n+1 and n+2, the one specific packet 50 that is transmitted 52 into the queue 55 is B₄ of 5 bytes. Thus, from the time=n+1 to time=n+2 the queue 55 again shrinks in overall byte size from 55 bytes (time=n+1) to 30 bytes (time=n+2) via the transmission out of queue 55 of 30 bytes (existing) and the transmission into the queue 55 of 5 bytes (new).

Thus, over time, be it at time=n, n+1, or n+2, and in between those times, the observation of bandwidth includes determining the rate of change of queue depth (i.e., dQD/dt) and the rate of bytes removed from the queue 55 (i.e., dBR/dt). From these observations, maximum bandwidth is obtained when DQD/dt is positive (i.e., >0) and as dBR/dt approaches 0 from the positive.

In this manner, over time, queue size, rate of transmission, the rates of change, and other observations regarding the queue 55 can be observed and measured. In aggregate, an observed aggregate bandwidth is obtained.

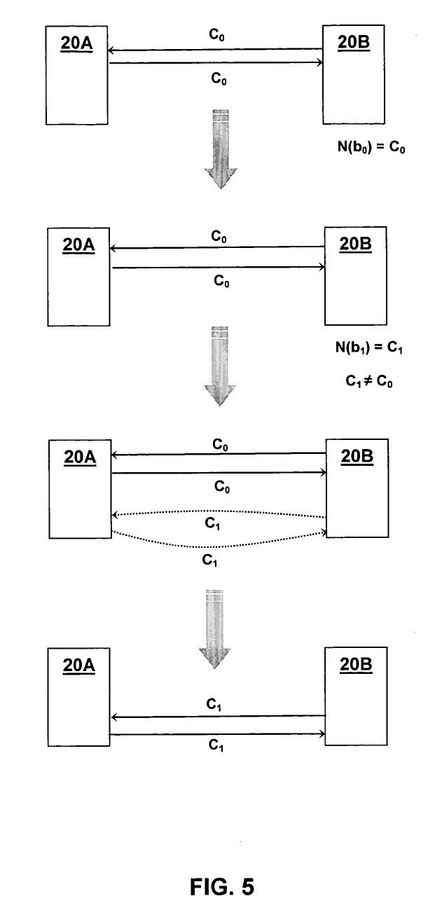

FIG. 5 shows a use in negotiating network optimization controls wherein the improved bandwidth delay product as calculated by the present invention is employed. Shown is communication traffic between two particular VPN endpoints 20A, 20B of a network in a progression over time.

A particular control set, C, is generated based on a function, N, of the calculated Bandwidth Delay Product, b. Equation 4 follows:
C=N(b) Eq. 4

Thus, for a particular control set, C₀, at an initial time, determines where traffic is conducted between two VPN endpoints 20A, 20B, as is depicted in first view. As the progression in FIG. 5 depicts, however, conditions in the network change over time, so that so that C, at a later time, alters such that C₁=N(b₁), wherein C₁≠C₀ because b₁≠b₀. As a result, traffic between VPN endpoints 20A, 20B is altered to a different optimization code path based upon the newly calculated C₁.

Note too that because the present invention can be utilized to estimate bandwidth delay product in either direction of data transmission (see above), the optimization code path may be set differently (i.e., independently) for the inbound and outbound transmissions. Thus, the present invention can be used in conjunction with asymmetric networks.

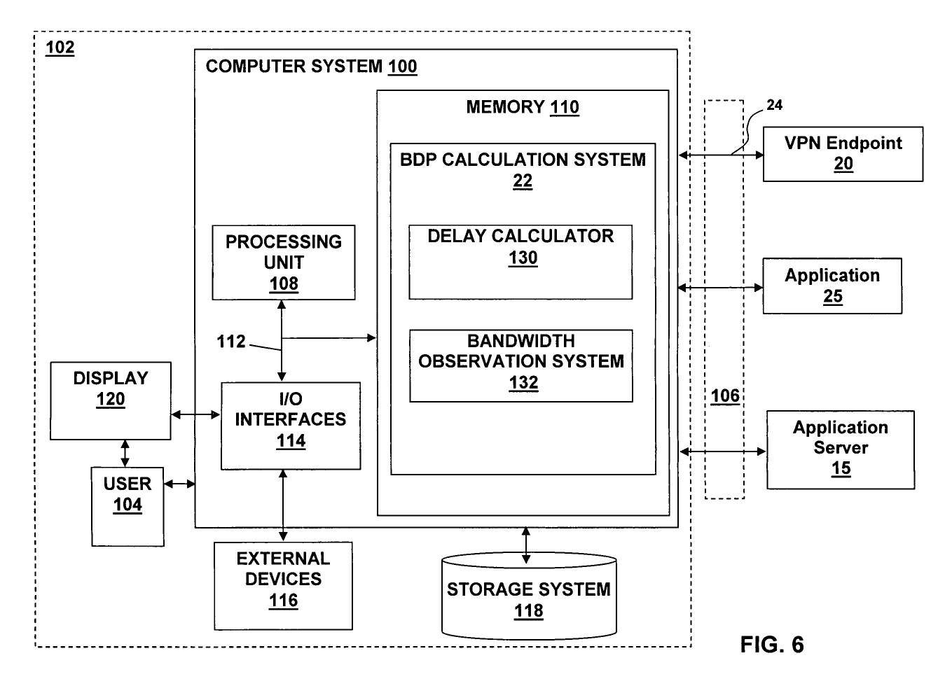

A computer system 100 for estimating bandwidth delay product from a single endpoint in accordance with an embodiment of the present invention is depicted in FIG. 6. Computer 100 comprises at least one VPN endpoint 20, an application 25, and an application server 15 in a distributed system. Computer system 100 is provided in a computer infrastructure 102. Computer system 100 is intended to represent any type of computer system capable of carrying out the teachings of the present invention. For example, computer system 100 can be a laptop computer, a desktop computer, a workstation, a handheld device, a server, a cluster of computers, etc. In addition, as will be further described below, computer system 100 can be deployed and/or operated by a service provider that provides a service estimating Bandwidth Delay Product from a single endpoint in accordance with the present invention. It should be appreciated that a user 104 can access computer system 100 directly, or can operate a computer system that communicates with computer system 100 over a network 106 (e.g., the Internet, a wide area network (WAN), a local area network (LAN), a virtual private network (VPN), etc). In the case of the latter, communications between computer system 100 and a user-operated computer system can occur via any combination of various types of communications links. For example, the communication links can comprise addressable connections that can utilize any combination of wired and/or wireless transmission methods. Where communications occur via the Internet, connectivity can be provided by conventional TCP/IP sockets-based protocol, and an Internet service provider can be used to establish connectivity to the Internet.

Computer system 100 is shown including a processing unit 108, a memory 110, a bus 112, and input/output (I/O) interfaces 114. Further, computer system 100 is shown in communication with external devices/resources 116 and one or more storage systems 118. In general, processing unit 108 executes computer program code, such as a BDP calculation system 22, that is stored in memory 110 and/or storage system(s) 118. While executing computer program code, processing unit 108 can read and/or write data, to/from memory 110, storage system(s) 118, and/or I/O interfaces 114. Bus 112 provides a communication link between each of the components in computer system 100. External devices/resources 116 can comprise any devices (e.g., keyboard, pointing device, display (e.g., display 120, printer, etc.) that enable a user to interact with computer system 100 and/or any devices (e.g., network card, modem, etc.) that enable computer system 100 to communicate with one or more other computing devices.

Computer infrastructure 102 is only illustrative of various types of computer infrastructures that can be used to implement the present invention. For example, in one embodiment, computer infrastructure 102 can comprise two or more computing devices (e.g., a server cluster) that communicate over a network (e.g., network 106) to perform the various process steps of the invention. Moreover, computer system 100 is only representative of the many types of computer systems that can be used in the practice of the present invention, each of which can include numerous combinations of hardware/software. For example, processing unit 108 can comprise a single processing unit, or can be distributed across one or more processing units in one or more locations, e.g., on a client and server. Similarly, memory 110 and/or storage system(s) 118 can comprise any combination of various types of data storage and/or transmission media that reside at one or more physical locations. Further, I/O interfaces 114 can comprise any system for exchanging information with one or more external devices/resources 116. Still further, it is understood that one or more additional components (e.g., system software, communication systems, cache memory, etc.) not shown in FIG. 6 can be included in computer system 100. However, if computer system 100 comprises a handheld device or the like, it is understood that one or more external devices/resources 116 (e.g., a display) and/or one or more storage system(s) 118 can be contained within computer system 100, and not externally as shown.

Storage system(s) 118 can be any type of system (e.g., a database) capable of providing storage for information under the present invention. To this extent, storage system(s) 118 can include one or more storage devices, such as a magnetic disk drive or an optical disk drive. In another embodiment, storage system(s) 118 can include data distributed across, for example, a local area network (LAN), wide area network (WAN) or a storage area network (SAN) (not shown). Moreover, although not shown, computer systems operated by user 104 can contain computerized components similar to those described above with regard to computer system 100.

Shown in memory 110 (e.g., as a computer program product) is a bandwidth delay product calculation system 22 for estimating bandwidth delay product from a single VPN endpoint (i.e., node) 20 in accordance with embodiments of the present invention. The BDP calculation system 22 includes a delay calculator 130 for calculating the time to acknowledge (i.e., delay) of a data packet leaving from and returning to the VPN endpoint 20, and a bandwidth observation system 132 for determining the observed aggregate bandwidth of a network based upon queue size, transmission rate, and other observations about the queue.

The present invention can be offered as a business method on a subscription or fee basis. For example, one or more components of the present invention can be created, maintained, supported, and/or deployed by a service provider that offers the functions described herein for customers. That is, a service provider can be used to provide a service for estimating bandwidth delay product from a single endpoint, as described above.

It should also be understood that the present invention can be realized in hardware, software, a propagated signal, or any combination thereof. Any kind of computer/server system(s)—or other apparatus adapted for carrying out the methods described herein—is suitable. A typical combination of hardware and software can include a general purpose computer system with a computer program that, when loaded and executed, carries out the respective methods described herein. Alternatively, a specific use computer, containing specialized hardware for carrying out one or more of the functional tasks of the invention, can be utilized. The present invention can also be embedded in a computer program product or a propagated signal, which comprises all the respective features enabling the implementation of the methods described herein, and which—when loaded in a computer system—is able to carry out these methods.

The invention can take the form of an entirely hardware embodiment, an entirely software embodiment, or an embodiment containing both hardware and software elements. In a preferred embodiment, the invention is implemented in software, which includes but is not limited to firmware, resident software, microcode, etc.

The present invention can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device), or a propagation medium. Examples of a computer-readable medium include a semiconductor or solid state memory, magnetic tape, removable computer diskette, random access memory (RAM), read-only memory (ROM), rigid magnetic disk and optical disk. Current examples of optical disks include a compact disk - read only disk (CD-ROM), a compact disk-read/write disk (CD-R/W), and a digital versatile disk (DVD).

Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

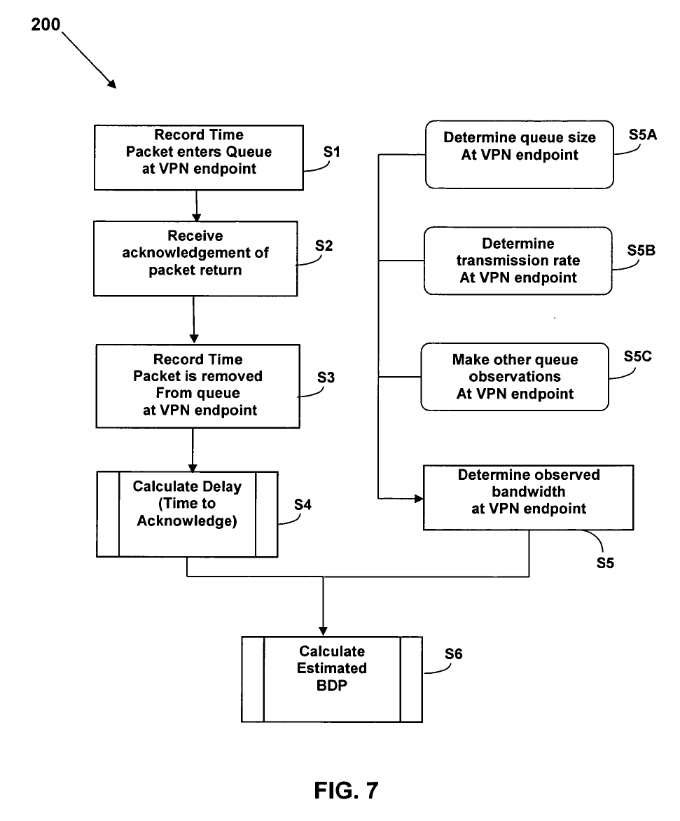

A flow diagram 200, of a process for estimating bandwidth delay product in accordance with an embodiment of the present invention is depicted in FIG. 7. The process, or method, 200 is described with reference to the networks 10 depicted in FIGS. 1 and 3, as well as the computer system 100 depicted in FIG. 6.

In step S1, the time that a packet 50 enters queue 55 at a VPN endpoint 20 is recorded. This initiates the first portion of the invention, depicted in part in FIGS. 1 and 2, where the time to acknowledge (i.e., delay) is obtained.

Step S2 follows, wherein after time passes, VPN endpoint 20 receives acknowledgement 60 of the packet 50 return. Step 3, includes removal of packet 50 from the queue 55 at which time, the time and byte count are recorded.

As discussed above regarding Equation 3, step S4, is the calculation of the delay (i.e., time to acknowledge) the packet 50.

The other “prong” of the process 200 includes step S5 which is the determination of the observed bandwidth at the VPN endpoint 20. The observed bandwidth may be an aggregation of one, two, or more observable, and measurable, aspects of the bandwidth at the VPN endpoint 20. These aspects are depicted in substeps S5A, S5B, and S5C, which together aggregate to form step S5. Thus, step S5 may include substep S5A, determining queue 55 size at the VPN endpoint 20. This is the rate of change of overall queue 55 depth. Step S5 may also include substep S5B, determining the transmission rate at the VPN endpoint 20. This is the rate of change, in bytes, of items being removed from the queue 55 due to acknowledgement of receipt by the peer. Step S5 may also include substep S5C, which is making other observations of the queue 55 at the VPN endpoint 20.

Finally, step S6 is the calculation of the estimated bandwidth delay product, which is multiplying delay, as calculated in step S4, times the bandwidth as determined under the observations made in step S5.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims.

What is claimed is:

1. A method for estimating bandwidth delay product at a single node, comprising:
calculating delay at the single node of a data packet transmission;
determining observed bandwidth at the single node; and
multiplying the delay by the observed bandwidth, thereby obtaining an estimated bandwidth delay product.

2. The method of claim 1, further comprising:
utilizing the estimated bandwidth delay product to optimize a network control.

3. The method of claim 1, wherein the single node is a virtual private network (VPN) endpoint.

4. The method of claim 1, wherein the calculating comprises:
recording time of entry into queue of the data packet.

5. The method of claim 4, wherein the calculating further comprises:
recording time of exit from queue of the data packet.

6. The method of claim 1, wherein the determining is selected from the group consisting of:
observing queue size, observing transmission rate, observing rate of change of queue depth, observing rate of byte removal from queue, and combinations thereof.

7. The method of claim 1, wherein data packet transmission is non-test data.

8. The method of claim 1, wherein the data packet transmission is to the node.

9. The method of claim 1, wherein the data packet transmission is from the node.

10. Deploying an application for estimating bandwidth delay product at a single node, comprising:
providing a computer infrastructure being operable to perform the method of claim 1.

11. Computer software embodied in a propagated signal for estimating bandwidth delay product at a single node, the computer software comprising instructions to cause a computer system to perform the method of claim 1.

12. A system for estimating bandwidth delay product at a single node, comprising:
a system for calculating delay at the single node of a data packet transmission;
a system for determining observed bandwidth at the single node; and
a system for multiplying the delay by the observed bandwidth, thereby obtaining an estimated bandwidth delay product.

13. The system of claim 12, further comprising:
a system for utilizing the estimated bandwidth delay product to optimize a network control.

14. The system of claim 12, wherein the single node is a virtual private network (VPN) endpoint.

15. The system of claim 12, wherein the calculating system further comprises:
a system for recording time of entry into queue of the data packet.

16. The system of claim 15, wherein the calculating system further comprises:
a system for recording time of exit from queue of the data packet.

17. The system of claim 12, wherein the system for determining is selected from the group consisting of:
system for observing queue size, system for observing transmission rate, system for observing rate of change of queue depth, system for observing rate of byte removal from queue, and combinations thereof.

18. The system of claim 12 wherein the data packet transmission is to the node.

19. The system of claim 12 wherein the data packet transmission is from the node.

20. A program product stored on a computer readable medium for estimating bandwidth delay product at a single node, the computer readable medium comprising program code for performing the steps of:
calculating delay at the single node of a data packet transmission;
determining observed bandwidth at the single node; and
multiplying the delay by the observed bandwidth, thereby obtaining an estimated bandwidth delay product.
